(19) United States
(12) Patent Application Publication
(10) Pub. No.: US 2004/0225840 A1
(43) Pub. Date: Nov. 11, 2004

(54) Apparatus and method to provide multithreaded computer processing

(76) Inventors: Dennis M. O'Connor, Chandler, AZ (US); Michael W. Morrow, Chandler, AZ (US); Stephen J. Strazdus, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/435,347

(22) Filed: May 9, 2003

(51) Int. Cl. G06F 12/00

(52) U.S. Cl. 711/122; 712/235

(57) ABSTRACT

Briefly, in accordance with an embodiment of the invention, an apparatus and method to provide multi-threaded computer processing is provided. The apparatus may include first and second processing units adapted to share a multi-bank cache memory, an instruction pre-decode unit, a multiply-accumulate unit, a coprocessor, and/or a translation lookaside buffer (TLB). The method may include sharing use of a multi-bank cache memory between at least two transaction initiators.

### BACKGROUND

Multi-threading may allow high-throughput, latency-tolerant architectures. Determining the appropriate methods and apparatuses to implement a multi-threaded architecture in a particular system may involve many factors such as, for example, efficient use of silicon area, power dissipation, and/or performance. System designers are continually searching for alternate ways to provide multi-threaded computer processing.

### BRIEF DESCRIPTION OF THE DRAWINGS

The subject matter regarded as the invention is particularly pointed out and distinctly claimed in the concluding portion of the specification. The present invention, however, both as to organization and method of operation, together with objects, features, and advantages thereof, may best be understood by reference to the following detailed description when read with the accompanying drawings in which:

FIG. 1 is a block diagram illustrating a computing system in accordance with an embodiment of the present invention; and

FIG. 2 is a block diagram illustrating a portion of a wireless device in accordance with an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the present invention. However, it will be understood by those skilled in the art that the present invention may be practiced without these specific details. In other instances, well-known methods, procedures, components and circuits have not been described in detail so as not to obscure the present invention.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

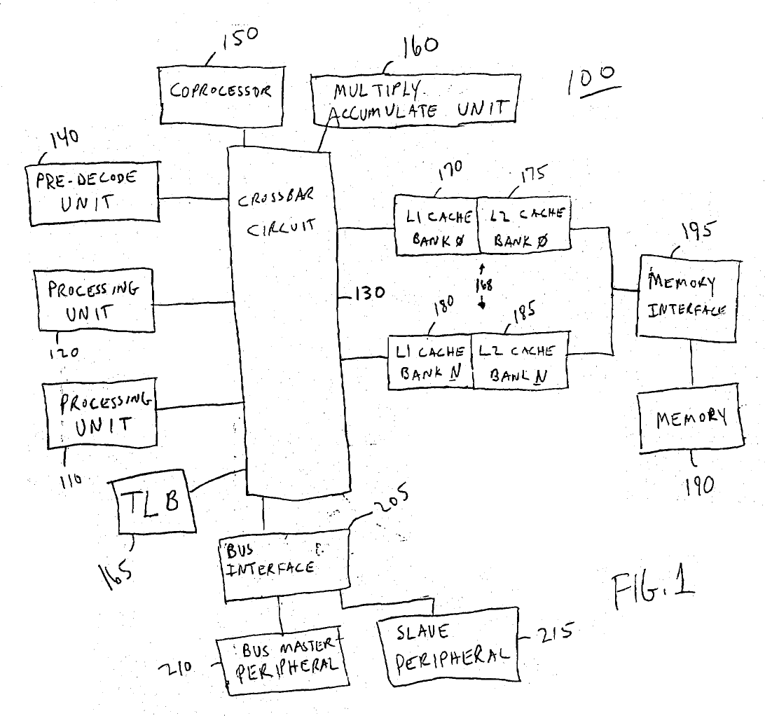

Turning to FIG. 1, an embodiment of a portion of a computing system 100 is illustrated. System 100 may comprise processing units 110 and 120 coupled to other components of system 100 using a crossbar circuit 130. Crossbar circuit 130 may allow any transaction initiator to talk to any transaction target. In one embodiment, crossbar circuit 130 may comprise one or more switches and data paths to transmit data from one part of system 100 to another. In the following description and claims, the term “data” may be used to refer to both data and instructions. In addition, the term “information” may be used to refer to data and instructions.

System 100 may further comprise a pre-decode unit 140, a coprocessor 150, a multiply-accumulate unit 160, and a translation lookaside buffer (TLB) 165 coupled to processing units 110 and 120 via crossbar circuit 130. In addition, system 100 may include a bus interface 205 coupled to processing units 110 and 120 via crossbar circuit 130. Bus interface 205 may also be referred to as a bus interface unit (BIU). Bus interface may be adapted to interface with devices external to the processor core.

System 100 may further include a bus mastering or bus master peripheral device 210 and a slave peripheral device 215 coupled to bus interface 205. In various embodiments, bus master peripheral device 210 may be a direct memory access (DMA) controller, graphics controller, network interface device, or another processor such as a digital signal processor (DSP). Slave peripheral device 215 may be a universal asynchronous receiver/transmitter (UART), display controller, read only memory (ROM), random access memory (RAM), or flash memory, although the scope of the present invention is not limited in this respect.

System 100 may further include a multi-bank cache memory 168 that may include multiple independent cache banks coupled to crossbar circuit 130. For example, system 100 may include a first bank of cache memory labeled bank 0, which may include a level 1 (L1) cache memory bank 170 coupled to a level 2 (L2) cache memory bank 175. System 100 may also include an additional N banks of cache memory labeled bank N, wherein each N bank may include a level 1 (L1) cache memory bank 180 coupled to a level 2 (L2) cache memory bank 185. In various embodiments, more than two banks of cache memory may be used, e.g., system 100 may include four banks of cache memory, although the scope of the present invention is not limited in this respect. The cache banks of cache memory 168 may be unified cache capable of storing both instructions and data.

Cache memory 168 may be a volatile or a nonvolatile memory capable of storing software instructions and/or data. Although the scope of the present invention is not limited in this respect, in one embodiment, cache memory 168 may be a volatile memory such as, for example, a static random access memory (SRAM), although the scope of the present invention is not limited in this respect.

The cache memory banks of cache memory 168 may be coupled to a storage device or memory 190, via a memory interface 195. Memory interface 195 may also be referred to as a memory controller and may be adapted to control the transfer of information to and from memory 190. Memory 190 may be a volatile or non-volatile memory. Although the scope of the present invention is not limited in this respect, memory 190 may be a static random access memory (SRAM), a dynamic random access memory (DRAM), a synchronous DRAM (SDRAM), a flash memory (NAND and NOR types, including multiple bits per cell), a disk memory, or any combination of these memories.

Processing units 110 and 120 may each comprise logic circuitry adapted to process software instructions to operate a computer. In one embodiment, processing units 110 and 120 may include at least an arithmetic logic unit (ALU) and a program counter to sequence instructions. Processing units 110 and 120 may each be referred to also as a processor, a processing core, a central processing unit (CPU), a microcontroller, or a microprocessor. Processing units 110 and 120 may also be generally referred to as clients or transaction initiators.

In one embodiment, processing unit 110 may be adapted to run one or more software processes. In other words, processing unit 110 may be adapted to process (i.e., execute or run) one or more than one thread or task of a software program. Similarly, processing unit 120 may be adapted to process one or more than one thread. Processing units 110 and 120 may be referred to as threaded processing units (TPUs). Since system 100 may be adapted to process more than one thread, it may be referred to as a multi-threaded computer processing system.

Although not shown in FIG. 1, in one embodiment, processing units 110 and 120 may each include an instruction cache, a register file, arithmetic logic unit (ALU), and translation lookaside buffer (TLB). In alternate embodiments, processing units 110 and 120 may include a data cache. It should be noted that although only two processing units are illustrated in system 100, this is not a limitation of the present invention. In alternate embodiments, more than two processing units may be used in system 100. In one embodiment, six processing units may be used in system 100.

The TLB in processing units 110 and 120 may assist in providing virtual-to-physical memory translation and may serve as a result cache for page table walks. Although the scope of the present invention is not limited in this respect, the TLB in processing units 110 and 120 may be adapted to store less than 100 entries, e.g., 12 entries in one embodiment. The TLB in processing units 110 and 120 may be referred to as a “micro-TLB.” The independent micro-TLBs of each processing unit may share use of or be used in cooperation with a larger TLB, e.g., TLB 165. For example, if a result is not found initially in a micro-TLB, then a search of the relatively larger TLB 165 may be performed during a virtual-to-physical address translation. Although the scope of the present invention is not limited in this respect, TLB 165 may be adapted to store at least 100 entries, e.g., 256 entries in one embodiment.

In one embodiment, the micro-TLB of a processing unit may provide both data and address translation for the one or more threads running on the processing unit. If a result is not found in the micro-TLB, i.e., a “miss” occurs, then TLB 165 that is shared among the processing units of system 100 (e.g., 110 and 120) may provide the translation. The use of a TLB reduces the number of page table walks that may need to be performed during virtual-to-physical address translation.

As is illustrated in the embodiment shown in FIG. 1, processing units 110 and 120 may be coupled to shared resources via crossbar circuit 130. These shared resources may include multi-bank cache memory 168, TLB 165, bus interface 205, coprocessor 150, multiply-accumulate unit 160, and pre-decode unit 140. Sharing resources may provide relatively higher throughput on multi-threaded workloads, and may make efficient use of silicon area and power consumption.

TLB 165 may contain hardware to perform page table walks, and may include a relatively large cache that stores the results of the page table walks. TLB 165 may be shared among all the processes running on the processing units of system 100. Processing units 110 and 120 may include the control logic for managing the entries in TLB 165, including locking entries into TLB 165. In addition, TLB 165 may provide to processing units 110 and 120 the information used to determine whether a memory operation targets the core's memory hierarchy or a device on one of the external buses.

Coprocessor 150 may include logic adapted to execute specific tasks. For example, although the scope of the present invention is not limited in this respect, coprocessor 150 may be adapted to perform digital video compression, digital audio compression, or floating point operations. Although only one coprocessor is illustrated in system 100, this is not a limitation of the present invention. In alternate embodiments, more than one coprocessor may be used in system 100.

Multiply-accumulate unit 160 may perform all operations involving multiplication, including multiply operations for a media instruction set. Multiply-accumulate unit 160 may also perform the accumulate function specified in some instruction sets.

Pre-decode unit 140 may be referred to as an instruction pre-decode unit and may translate or convert instructions from one type of instruction set to instructions of another type of instruction set. For example, pre-decode unit 140 may convert Thumb® and ARM® instruction sets into an internal instruction format that may be used by processing units 110 and 120. In response to an instruction fetch, the result of the instruction fetch from cache memory 168 or memory 190 may be routed through pre-decode unit 140. Then, the converted instructions may be transmitted to the instruction cache of the processing unit that initiated the instruction fetch.

Some components of system 100 may be integrated (“on-chip”) together, while others may be external (“off-chip”) to the other components of system 100. In one embodiment, processing units 110 and 120, pre-decode unit 140, multiply-accumulate unit 160, TLB 165, cache memory 168, crossbar circuit 130, memory interface 195, and bus interface 205 may be integrated (“on-chip”) together, while coprocessor 150, memory 190, bus master peripheral 210, and slave peripheral 215 may be “off-chip.” In one embodiment, during operation, instructions may be fetched using a physical address supplied by processing units 110 and 120, using the appropriate cache bank of cache memory 168. Then these instructions may be routed through the pre-decode unit 140, and placed in instruction caches within the appropriate processing unit.

In one embodiment, commonly executed data-manipulation operations (such as arithmetic and logical operations, compares, branches and some coprocessor operations) may be performed completely within processing units 110 and 120. Complicated and/or rarely used data manipulation operations (such as multiply) may be processed by processing units 110 and 120 reading the operands from the register file and then sending the operands and a command to a shared execution unit, such as multiply-accumulate unit 160, which then may return the results (if any) to the processing unit when they are ready.

In one embodiment, instructions that read or write memory may have their permissions and physical addresses determined in the processing units, and then may send a read or write command to the appropriate cache bank. Virtual-to-physical address translation may be handled within the processing units by the micro-TLBs of the processing units that cache entries from the relatively larger shared TLB 165.

In one embodiment, instructions that read or write to devices on the external bus or buses may have their permissions and physical addresses determined in processing units 110 and 120, and then may send a read or write command to the appropriate external bus controller. Coprocessor instructions may either be executed within the processing units 110 and 120, or sent (with their operands if necessary) to an on- or off-core coprocessor, that may returns the results (if any) to processing units 110 and 120 when they are ready.

In some embodiments, the architecture discussed above may enable processing units that may run at higher speeds, and may make more efficient use of silicon and may reduce power consumption by sharing resources (e.g., cache memory, TLB, multiply-accumulate unit, coprocessors, etc.) that may not be used frequently.

Accordingly, some embodiments may partition resources of system 100 into to those shared by threads and those not shared by threads.

Banking cache memory 168 may provide relatively high bandwidth to serve all threads. Multi-bank cache memory 168 may provide the ability to process multiple memory requests during each clock cycle. For example, a four-bank memory system may field up to four memory operations each clock. Banked storage may mean dividing the memory into independent banked regions that may be simultaneously accessed during the same clock cycle by different processing units or other components of system 100. The banked caches may allow for “parallelism” in the form of simultaneous access. For example, for two banks of cache memory, e.g., bank A and B, one processing unit may be probing address x in cache bank A, while another processing unit may be probing address y in cache bank B. In one embodiment, at least two memory operations (read or write) may be initiated by processing units 110 and 120 and these memory operations may be performed during a single clock cycle of a clock signal coupled to multi-bank cache memory 168.

It should be noted that in some embodiments, all memory-mapped devices in system 100, including all cache banks, may be accessible to all threads in all processing units, to all bus-mastering devices, and to devices coupled to an off-chip bus.

In one embodiment, banking of the cache memory may be achieved by dividing the memory address space into a power-of-two number of independent sub-spaces, each of which may be independent of the other. In addition to being logically independent, the different banks of cache memory may also be physically independent or separate cache memories.

Since the subset of the address space served by each bank may be completely independent of the other subsets served by the other banks, there may be no need for any communication between each bank. Thus, there may be no use of software coherency management for cache memory 168 in this embodiment.

The splitting of cache memory 168 space into banks, starting at the L1 caches may continue into the L2 caches, as is illustrated in the embodiment shown in FIG. 1. If desired, the splitting or banking may even be continued into memory 190, which may be used for long term storage of information. In one embodiment, every L1 cache bank may have a dedicated L2 cache bank that may only be accessible by the associated L1 cache bank. In addition, the L2 caches of each bank may communicate with a single shared memory system (e.g., memory 190). Alternatively, memory 190 may be a banked memory, wherein each L2 bank may communicate with a designated bank in memory 190.

In one embodiment, in response to a memory request, the L1 cache bank may first be searched. If there is a L1 “hit,” then the result may be returned to the transaction initiator. If there is a L1 “miss,” then the dedicated L2 cache bank associated with the L1 cache bank may then be searched for the requested information. If there is a L2 miss, then the request may be sent to memory 190.

An address may be used to access information from a particular location in memory. One or more bits of this address may be used to split the memory space into separate banks. For example, in one embodiment, the address may be a 32-bit address, and one or more of bits 11 through 6, i.e., bits [11:6], of the 32-bit address may be used to split the memory space.

In one embodiment, the L1 and L2 caches of each bank may be physically addressed, and the splitting of the memory space may be done using bits from the physical address of an access as discussed above. The lowest practical granularity for the bank splitting may be a cache line, which may be 64 bytes.

The L1 and L2 caches of a bank may be tightly coupled, which may improve the latency of L2 cache accesses. Also, the L2 may be implemented as a “victim cache” for the L1, e.g., data may be moved between the L1 and the L2 a complete cache line at a time. The motivation for this may be the error correction code (ECC) protection that may be used on the L2 data cache but not on the L1 data cache, which may have byte-parity protection instead. Ensuring that all accesses to the L2 are complete lines may eliminate the need to do a Read-Modify-ECC-Write cycle in the L2 cache, which may simplify its design. As a secondary benefit, using the L2 cache as a victim cache for the L1 cache may improve the efficiency of the caches, since fewer, if any, lines may be duplicated at the L1 and L2 levels. The L1/L2 may be implemented to be “exclusive.” In one embodiment, a cache bank may support at least 64-bit load and store operations. Wider data transfers may be supported for the external bus masters and for fills returning from the backing memory system, e.g., memory 190. Spills to the backing memory system may be provided at the width of the backing memory interface, which may be at least 64 bits in one embodiment.

In one embodiment, a cache bank may support unaligned data transfer operations that do not span a cache line, and may not support unaligned access that cross a cache line. The processing units and bus interfaces of system 100 may ensure that all data transfer operations sent to the caches conform to this restriction.

A cache may support hit-under-miss and miss-under-miss operation. The cache may also support locking of lines into cache and may accept a “Low Locality of Reference” tag on each transaction they receive, which may be used to reduce cache pollution under some circumstances. The caches may accept Pre-Load operations.

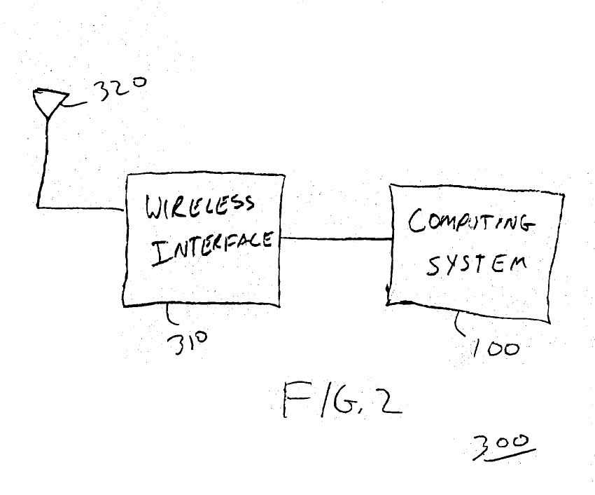

FIG. 2 is a block diagram of a portion of a wireless device 300 in accordance with an embodiment of the present invention. Wireless device 300 may be a personal digital assistant (PDA), a laptop or portable computer with wireless capability, a web tablet, a wireless telephone, a pager, an instant messaging device, a digital music player, a digital camera, or other devices that may be adapted to transmit and/or receive information wirelessly. Wireless device 300 may be used in any of the following systems: a wireless local area network (WLAN) system, a wireless personal area network (WPAN) system, or a cellular network, although the scope of the present invention is not limited in this respect.

As shown in FIG. 2, in one embodiment wireless device 300 may include computing system 100, a wireless interface 310, and an antenna 320. As discussed herein, in one embodiment, computing system 100 may provide multi-threaded computer processing and may include processing unit 110 and processing unit 120, wherein processing units 110 and 120 may be adapted to share multi-bank cache memory 168, instruction pre-decode unit 140, multiply-accumulate unit 160, coprocessor 150, and/or translation lookaside buffer (TLB) 165.

In various embodiments, antenna 320 may be a dipole antenna, helical antenna, global system for mobile communication (GSM), code division multiple access (CDMA), or another antenna adapted to wirelessly communicate information. Wireless interface 310 may be a wireless transceiver.

Although computing system 100 is illustrated as being used in a wireless device, this is not a limitation of the present invention. In alternate embodiments computing system 100 may be used in non-wireless devices such as, for example, a server, desktop, or embedded device not adapted to wirelessly communicate information.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. An apparatus, comprising:
a first processing unit;
a second processing unit;
a first cache memory coupled to the first and second processing units; and
a second cache memory coupled to the first and second processing units.

2. The apparatus of claim 1, wherein the first processing unit is adapted to process one or more software threads and wherein the second processing unit is adapted to process one or more software threads.

3. The apparatus of claim 1, wherein the first processing unit includes:
an instruction cache;
a register file;
an arithmetic logic unit (ALU); and
a translation lookaside buffer (TLB).

4. The apparatus of claim 3, wherein the translation lookaside buffer is adapated to store less than 100 entries.

5. The apparatus of claim 1, further comprising a coprocessor coupled to the first and second processing units.

6. The apparatus of claim 1, further comprising a translation lookaside buffer (TLB) coupled to the first and second processing units.

7. The apparatus of claim 6, wherein the translation lookaside buffer is adapted to store at least 100 entries.

8. The apparatus of claim 1, further comprising a multiply-accumulate unit coupled to the first and second processing units, wherein the multiply-accumulate unit is adapted to perform multiply and accumulate operations.

9. The apparatus of claim 1, further comprising an instruction pre-decode unit coupled to the first and second processing units.

10. The apparatus of claim 1, wherein the first cache memory is a first cache memory bank and wherein the second cache memory is a second cache memory bank independent of the first cache memory bank.

11. The apparatus of claim 1, wherein the first cache memory includes:
a first level 1 (L1) cache memory; and
a first level 2 (L2) cache memory coupled to the first level 1 cache memory.

12. The apparatus of claim 11, wherein the second cache memory includes:
a second level 1 (L1) cache memory; and
a second level 2 (L2) cache memory coupled to the second level 1 cache memory.

13. The apparatus of claim 12, wherein the second level 2 cache memory is independent of the first level 2 cache memory.

14. The apparatus of claim 1, further comprising another memory coupled to the first cache memory and the second cache memory.

15. The apparatus of claim 1, wherein the another memory is a static random access memory (SRAM), a dynamic random access memory (DRAM), a synchronous DRAM (SDRAM), a flash memory, or a disk memory.

16. The apparatus of claim 1, further comprising a bus-master device coupled to the first cache memory and the second cache memory.

17. The apparatus of claim 16, wherein the bus-master device is a direct memory access (DMA) controller.

18. The apparatus of claim 1, wherein the first cache memory is coupled to the first and second processing units via a crossbar circuit.

19. An apparatus, comprising:
a first processing unit adapted to process one or more software threads;
a second processing unit adapted to process one or more software threads; and
a first translation lookaside buffer (TLB) coupled to the first and second processing units.

20. The apparatus of claim 19, further comprising:
a first cache memory bank coupled to the first and second processing units; and
a second cache memory bank coupled to the first and second processing units.

21. The apparatus of claim 19, wherein the first processing unit includes:
an instruction cache;
a register file;
arithmetic logic unit (ALU); and
a second translation lookaside buffer (TLB) coupled to the first translation lookaside buffer.

22. The apparatus of claim 21, wherein the first TLB is adapted to store at least 100 entries and the second TLB is adapted to store less than 100 entries.

23. An apparatus, comprising:
a first processing unit;
a second processing unit; and
a multiply-accumulate unit coupled to the first and second processing units.

24. The apparatus of claim 23, further comprising:
a first cache memory bank coupled to the first and second processing units; and
a second cache memory bank coupled to the first and second processing units,
wherein the first cache memory bank includes:
a first level 1 (L1) cache memory; and
a first level 2 (L2) cache memory coupled to the first level 1 cache memory;
wherein the second cache memory bank includes:
a second level 1 (L1) cache memory; and
a second level 2 (L2) cache memory coupled to the second level 1 cache memory.

25. The apparatus of claim 23, wherein the first processing unit is adapted to process one or more software processes and wherein the second processing unit is adapted to process one or more software processes.

26. An apparatus, comprising:
a first processing unit;
a second processing unit; and
an instruction pre-decode unit coupled to the first and second processing units.

27. The apparatus of claim 26, wherein the first processing unit is adapted to process one or more software processes and wherein the second processing unit is adapted to process one or more software processes.

28. The apparatus of claim 26, further comprising:
a first cache memory bank coupled to the first and second processing units; and
a second cache memory bank coupled to the first and second processing units,
wherein the first cache memory bank includes:
a first level 1 (L1) cache memory; and
a first level 2 (L2) cache memory coupled to the first level 1 cache memory;
wherein the second cache memory bank includes:
a second level 1 (L1) cache memory; and
a second level 2 (L2) cache memory coupled to the second level 1 cache memory.

29. An apparatus, comprising:
a first processing unit; and
a second processing unit, wherein the first and second processing units are adapted to share a multi-bank cache memory, an instruction pre-decode unit, a multiply-accumulate unit, a coprocessor, or a translation lookaside buffer (TLB).

30. The apparatus of claim 29, wherein the first and second processing units are each adapted to process one or more software threads.

31. A system, comprising:
a wireless transceiver;
a first processing unit coupled to the wireless transceiver;
a second processing unit;
a first cache memory coupled to the first and second processing units; and
a second cache memory coupled to the first and second processing units.

32. The system of claim 31, further comprising a dipole antenna coupled to the wireless transceiver.

33. The system of claim 31, wherein the first processing unit is adapted to process one or more software threads and wherein the second processing unit is adapted to process one or more software threads.

34. A method to provide multi-threaded computer processing, comprising:
sharing use of a multi-bank cache memory between at least two transaction initiators.

35. The method of claim 34, wherein the at least two transaction initiators are two processing units, wherein each of the two processing units is adapted to process one or more software threads.

36. The method of claim 34, further comprising:
sharing use of a translation lookaside buffer (TLB) between the at least two transaction initiators;
sharing use of an instruction pre-decode unit between the at least two transaction initiators;
sharing use of a coprocessor between the at least two transaction initiators; and
sharing use of a multiply-accumulate unit between the at least two transaction initiators.

37. The method of claim 34, further comprising performing at least two memory operations initiated by the at least two transaction initiators during a single clock cycle of a clock signal coupled to the multi-bank cache memory.
